(19) United States
(12) Patent Application Publication
(10) Pub. No.: US 2015/0214798 A1
(43) Pub. Date: Jul. 30, 2015

(54) PERMANENT MAGNET DYNAMOELECTRIC MACHINE

(71) Applicant: AIDA ENGINEERING, LTD., Kanagawa (JP)

(72) Inventors: Fumio TAJIMA, Sagamihara (JP); Yoshihiro YAMAGUCHI, Sagamihara (JP); Kazuhiro HASEGAWA, Sagamihara (JP); Koji CHOSA, Sagamihara (JP); Katsumi SHIBATA, Sagamihara (JP)

(21) Appl. No.: 14/598,101

(22) Filed: Jan. 15, 2015

(30) Foreign Application Priority Data
Jan. 17, 2014 (JP) 2014-006684

(51) Int. Cl. H02K 1/28; H02K 1/27

(52) U.S. Cl. CPC H02K 1/28; H02K 1/278

(57) ABSTRACT

A permanent magnet dynamoelectric machine of surface magnet type is configured to have a flanged U-shaped magnet presser made of a conductive metal, and to fix the magnet presser to a rotor core using a fixing member so as to fix a part of an outer periphery of a permanent magnet in a radial direction with a flange of the magnet presser. This ensures the permanent magnet dynamoelectric machine of surface magnet type to be adaptable to large-torque, high-speed and large-capacity.

### TECHNICAL FIELD

The present invention relates to a permanent magnet dynamoelectric machine, and more particularly, to a permanent magnet dynamoelectric machine that ensures high-speed, large-capacity, and low torque ripple.

### BACKGROUND

As performance of rare earth magnet, especially, neodymium magnet becomes higher, the permanent magnet dynamoelectric machine that uses such magnet has been designed to exhibit larger torque, larger capacity, and to operate at higher speed. The aforementioned machine is represented by the driving permanent magnet dynamoelectric machine for electric press with specification of the torque set to several tens of kNm, the rotating speed set to several hundreds of rotations/minute, and the capacity set as far as 1000 kW. The aforementioned permanent magnet dynamoelectric machine uses the neodymium magnet as the high-performance permanent magnet. Therefore, the reluctance torque does not have to be utilized. There are many cases of employing so-called surface magnet type permanent magnet dynamoelectric machine having the permanent magnets disposed on the outer surface of the rotor core. The aforementioned structure realizes the permanent magnet dynamoelectric machine which generates the torque substantially proportional to the current, that is, excellent servo characteristic, high torque density relative to the constitution, and low torque ripple.

Meanwhile, in order to meet requirements of the enlarged host device and decreased cost of the dynamoelectric machine, further increase in the capacity (torque x number of rotations) of the permanent magnet dynamoelectric machine for the same constitution has been demanded. This may be established by realizing high-speed operation of the dynamoelectric machine while minimizing the cost increase.

The high-speed and large-capacity permanent magnet dynamoelectric machine of surface magnet type needs to establish the rigid magnet holding mechanism, minimize the loss generated in the rotor, and reduce the torque ripple.

The permanent magnet dynamoelectric machine for electric press is configured to have a permanent magnet rotor formed by housing the permanent magnet in the laminated silicon steel plate, that is, embedded type, which has both a merit and a demerit compared with the permanent magnet dynamoelectric machine of surface magnet type. The present invention is applied to the permanent magnet dynamoelectric machine of surface magnet type, which exhibits the aforementioned characteristics.

The permanent magnet dynamoelectric machine of surface magnet type is configured to dispose the permanent magnet on the rotor surface, and the magnet presser between the permanent magnets. The conductive metallic magnet presser is especially excellent for ensuring the strength. Meanwhile, the conductive metallic magnet presser generates the eddy current loss therein owing to the airgap flux of the permanent magnet and the magnet flux generated by the stator winding, which may prevent the high-speed operation of the dynamoelectric machine. The eddy current loss adversely affects the capacity increase of the structure with the same constitution.

Japanese Unexamined Patent Application Publication No. 2013-62897 discloses the magnet holding of the permanent magnet dynamoelectric machine of the aforementioned type. It discloses the structure of surface magnet type, which uses the T-shaped magnet presser as the magnet holding member between permanent magnets disposed on the outer circumference of the rotor core for positioning the permanent magnet in the circumferential direction and holding the magnet.

Japanese Unexamined Patent Application Publication No. 9-19092 discloses another method of holding the magnet. It discloses that slopes are formed at both ends of each permanent magnet, and a spacer with the slope corresponding to the slope of the permanent magnet is interposed between those permanent magnets, and fixed to the rotor core with the screw. In this case, the spacers have the respective thicknesses in the circumferential direction changed alternately so as to include the first spacer with substantially the same thickness as that of the magnet, which is fixed to the rotor core, and the second spacer with the thickness smaller than that of the permanent magnet to have an airgap from the rotor core, which is fixed to the slope of the permanent magnet with the fixing member.

Japanese Unexamined Patent Application Publication No. 2001-268830 discloses another magnet holding method. It is configured such that a plurality of segment type permanent magnets each having the thickness reduced at the outer circumferential end substantially in tapered manner, which are arranged at equal intervals with one another, and a groove is formed in the axial direction in the outer circumferential surface of the cylindrical yoke. The aforementioned positions correspond to the intervals of the Permanent magnets. A rail-like member formed by integrating a wedge part for pressing the outer circumferential end of the segment type permanent magnet and the fitting part that fits with the groove of the cylindrical yoke is inserted in the axial direction so that the permanent magnet, the yoke and the rail-like member are integrally fixed with the adhesive.

Japanese Unexamined Patent Application Publication No. 2013-135506 discloses another magnet holding method. It is configured such that the T-shaped magnet holder axially extending from the resin disk-shaped holder is disposed between the permanent magnets. The holder is fixed to the disk placed at opposite side of the disk-shaped holder in the axial direction to hold the permanent magnet.

In Japanese Unexamined Patent Application Publication No. 2013-62897, the material for forming the magnet presser is not specified. However, the non-metallic magnet presser exhibits insufficient strength. When using the conductive metal for forming the magnet presser, the permanent magnet is fixed from the outer circumference by the T-shaped magnet presser so that the magnet is held while coping with centrifugal force to the outer circumference and the torque in the circumferential direction. Meanwhile, the following problems still exist. A first problem is that the magnet presser is disposed to reach the position near the stator surface on the magnet surface, and accordingly, large eddy current may be generated by the ripple in the airgap flux under the influence of the slit in the inner circumferential surface of the slot of the stator core in the non-load state, and by the ripple in the airgap flux under the higher harmonic wave magnetcmotive force of the stator winding in the load state. A second problem is that the torque ripple becomes large as the thickness of the magnet is constant in the circumferential direction so that the airgap flux density of the permanent magnet has a large content of higher harmonic wave. A third problem is that the T-shaped magnet presser is in direct contact with the rotor core without leaving the gap therebetween, which prevents application of the pressing force to the permanent magnet in the radial direction. A fourth problem is that the outer peripheral position of the T-shaped magnet presser is located outside the cuter periphery of the permanent magnet, which increases the magnetic airgap length of the permanent magnet, thus reducing the torque.

Japanese Unexamined Patent Application Publication No. 9-19092 has problems as described below. That is, the first problem is that the slope on the side surface of the permanent magnet is configured to be held. It is therefore difficult to firmly fix the centrifugal force applied to the permanent magnet in the radial direction. The second problem is that the magnet presser is disposed to reach the permanent magnet surface, and the use of the conductive metallic magnet presser generates the eddy current loss. The third problem is that the constant thickness of the magnet in the circumferential direction causes the torque ripple.

Japanese Unexamined Patent Application Publication No. 2001-268830 has problems as described below. That is, the first problem is that the rail-like magnet presser has one end disposed on the rotor core, and the other end disposed on the outer periphery of the permanent magnet, which hardly applies the force to the permanent magnet in the radial direction. It is therefore difficult to be applied to the high-torque dynamoelectric machine. The second problem is that the magnet presser is at substantially the same position as the outer periphery of the permanent magnet. Then the use of the conductive metallic magnet presser may have the risk of causing the eddy current loss.

Japanese Unexamined Patent Application Publication No. 2013-135506 discloses that the resin magnet presser is fixed with the disks at both axial ends from the axial direction. In the case of the compact permanent magnet dynamoelectric machine, it is possible to ensure the strength. However, the strength cannot be ensured for the surface magnet type permanent magnet dynamoelectric machine with large-torque, high-speed and large-capacity.

The aforementioned related art does not disclose the structure that allows lessening of the eddy current loss in the conductive metallic magnet presser while using a conductive metal that ensures the mechanical strength.

### SUMMARY OF THE INVENTION

In order to solve the problems above, the configurations described in the claims are adopted. The present invention includes a plurality of solutions for the problems above, and one example provides a permanent magnet dynamoelectric machine having a stator formed by winding a stator winding around a laminated stator core, and a permanent magnet rotor on an inner circumference of the stator, which includes a shaft, a rotor core, permanent magnets, each of which is made of a segment-shaped rare earth magnet, and disposed to have adjacent polarities alternately changed on an outer circumference of the rotor core, and a magnet presser which determines a circumferential position of the permanent magnet and presses a part of an outer periphery of the permanent magnet. The magnet presser is made of a conductive metal, and formed to have a flanged U-like shape. The magnet presser is fixed to the rotor core with a fixing member so as to fix the part of the outer periphery of the permanent magnet in a radial direction with a flange of the magnet presser.

The present invention provides the surface magnet type permanent magnet dynamoelectric machine that allows reduction both in the pulsation torque and the eddy current loss generated in the magnet presser, and the rigid magnet holding mechanism, which is adaptable to the large-torque, high-speed and large-capacity.

### BRIEF DESCRIPTION OF THE DRAWINGS

FIG. 1 is a sectional view of a permanent magnet dynamoelectric machine according to a first embodiment;

FIG. 2 is an axial sectional view of the permanent magnet dynamoelectric machine according to the first embodiment;

FIG. 3 is an enlarged view of an essential part of the permanent magnet dynamoelectric machine according to the first embodiment;

FIGS. 4A to 4D represent the outline of a magnet presser of the permanent magnet dynamoelectric machine according to the first embodiment;

FIGS. 5A and 55 are explanatory views of the principle concerning generation of the eddy current in the magnet presser according to the first embodiment;

FIG. 6 graphically represents analytical results of the magnetic flux density fluctuation and eddy current loss generated in the magnet presser at its outermost periphery according to the first embodiment; and

FIGS. 7A and 7B represent the outline of the magnet presser of the permanent magnet dynamoelectric machine according to a second embodiment.

### DESCRIPTION OF A PREFERRED EMBODIMENT

Embodiments of the present invention will be described referring to the drawings.

### First Embodiment

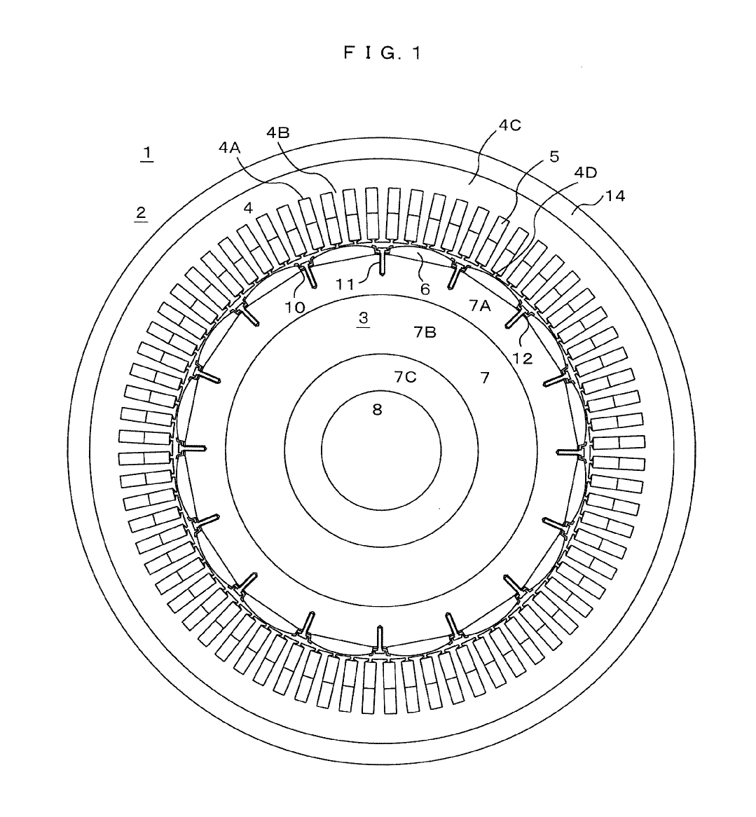

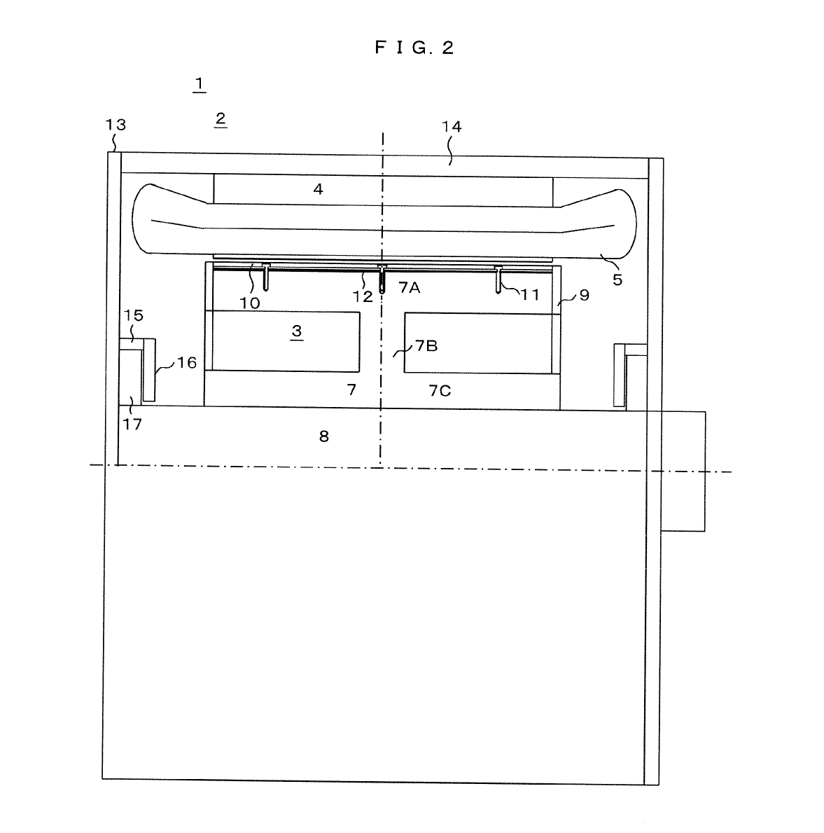

FIG. 1 is a sectional view, and FIG. 2 is an axial sectional view of a permanent magnet dynamoelectric machine according to the embodiment. Underlined numerals represent assemblies of components of the structure.

Referring to FIG. 1, a permanent magnet dynamoelectric machine 1 includes a stator 2 and a rotor 3. The stator 2 includes a stator core 4, a stator winding 5, a frame 14 on the outer circumference of the stator core, and an end plate 13 disposed at both axial ends of the frame as shown in FIG. 2.

The stator core 4 is made of a laminated silicon steel plate, and includes a slot 4A for housing the stator winding, stator teeth 4B that constitute the magnetic circuit at the stator side of the permanent magnet, a stator core back 4C, and a stator slit 4D serving as an insertion opening through which the stator winding 5 is inserted into the slot 4A. The stator winding 5 is formed through double-layer winding and distributed winding at the inner and outer circumferential sides of the slot 4A.

The rotor 3 includes a permanent magnet 6, a rotor core 7, a shaft 8, a rotor plate 9 for suppressing the axial movement of the permanent magnet 6 as shown in FIG. 2, and a magnet presser 10 for supporting the centrifugal force in the radial direction applied to the permanent magnet.

The permanent magnet dynamoelectric machine according to the embodiment has the specified torque set to several tens of kNm, the rotation speed set to several hundreds of rotations/minute, and the capacity set to 1000 kW. However, a more compact dynamoelectric machine may also be applied. The dynamoelectric machine is specified to have the permanent magnet 6 made of high performance rare earth magnet (especially, neodymium magnet) which ensures improvement of the torque density. It is specified to use approximately 20 Kg or more permanent magnets for the single unit of the machine, or use the rotor with outer diameter of 400 mm or larger. However, a more compact dynamoelectric machine may be applied. The permanent magnets 6 are disposed to have N poles and S poles alternately arranged in the circumferential direction.

Referring to FIG. 2, the rotor core 7 includes a rotor core outer circumferential cylinder portion 7A which constitutes the magnetic circuit at the rotor side of the permanent magnet, a rotor core inner circumferential cylinder portion 7C which transmits the torque generated by the permanent magnet to the shaft 8, and a rotor rib 7B which connects those portions. It is assumed that the rotor core 7 is produced from the block core. As FIGS. 1 and 2 show, the magnet pressers 10 are fixed to the rotor core 7 with fixing members 11 (bolts in this case) at a plurality of points in the axial direction so as to press the permanent magnets 6 against the rotor core 7.

As FIG. 2 shows, the stator 2 rotatably holds the rotor 3 via a bearing 17. The bearing 17 is housed in a bearing case 15 fixed to the end plate 13 with a bearing cover 16.

A rotary sensor (description is omitted) of the rotor 3 for detecting the magnetic pole position of the permanent magnet 6 is to be attached to the shaft. The control unit is provided for controlling the current applied to the stator winding 5 in accordance with the detected position information.

In this embodiment, the number of slots N of the stator core 4 is set to 72, and the number of poles P of the rotor 3 is set to 16 as the example. Generally, the number 3 is selected for the number of phases M of the stator winding 5 of the dynamoelectric machine 1. That is, the number of the slots for each pole at each phase Nspp=N/P/M is set to 3/2 as the fractional slot rather than the integer slot. The number of the slots of the stator 2 set to 72 and the number of poles of the rotor set to 16 represent the structure having successive 8 cycles of a slot combination with the number of slots set to 9 and the number of poles of the rotor set to 2.

The aforementioned structure provides advantages including the first advantage of increasing the frequency of the cogging torque expressed by the least common multiple of the numbers of the poles and the slots so as to reduce the cogging torque, and the second advantage of reducing the torque ripple upon application of the stator winding current as it is possible to set the different phase for each wire of the stator winding of the single phase.

The permanent magnet dynamoelectric machine 1 according to the embodiment is configured such that the stator winding 5 has successive 8 cycles of the combination of 2-pole and 9-slot. The inverter with the capacity ⅛ of the entire capacity is connected to each of the stator windings 5 for driving so as to allow the use of a plurality of versatile compact inverters each at a relatively low cost compared with the case where the single large-capacity inverter is used for driving. This makes it possible to easily increase the capacity at a low cost.

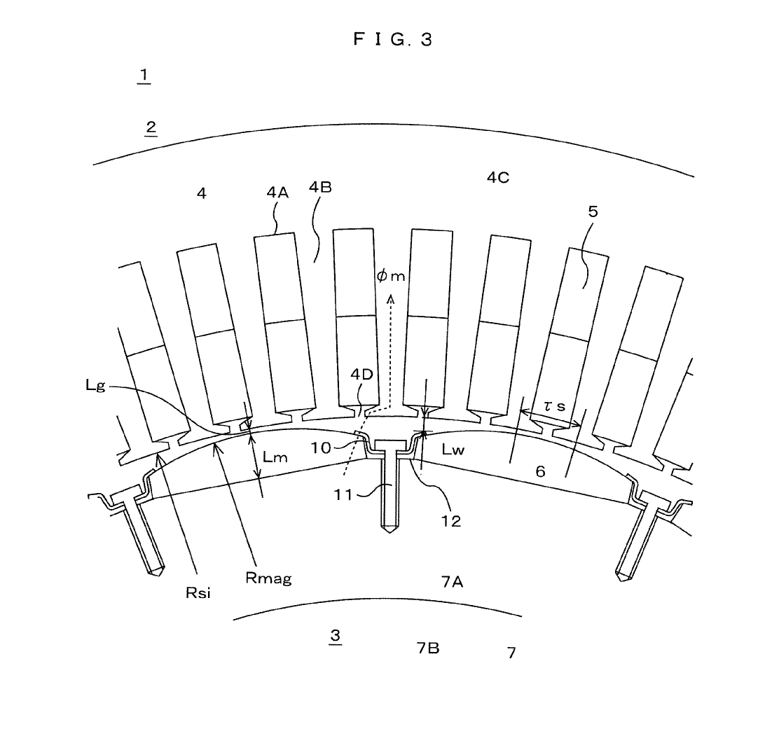

FIG. 3 is an enlarged view of an essential part of the permanent magnet dynamoelectric machine of the embodiment. Referring to FIG. 3, in the embodiment, an outer peripheral radius Rmag of the permanent magnet is equal to or smaller than ½ of the inner radius Rsi of the stator, and has a segment configuration as illustrated by the drawing. In other words, the thickness of the permanent magnet is gradually reduced in the circumferential direction. This configuration provides the following advantages. The first advantage is that the multiplier effect derived from reduced thickness of the magnet and increased airgap length enables the airgap flux density at both ends of the permanent magnet 6 to be made small relative to the one at the center of the permanent magnet. This makes it possible to approximate the airgap flux density to the sinusoidal magnetic flux distribution compared with the case where the airgap length and the permanent magnet length are kept constant. This is effective for reducing both the torque ripple (dogging torque) in the non-load state, and the torque ripple in the load state. The second advantage is that each thickness at both ends of the permanent magnet may be made small, which enables to form the space corresponding to the difference between the thickness Lm of the permanent magnet at the center and the thickness of the magnet at both ends of the permanent magnet. This makes it possible to allow the rigid magnet holding configuration with small eddy current generation.

Referring to FIG. 3, the difference between the outermost periphery of the magnet presser 10 and the inner diameter of the stator core 4 is set to Lw, the slot pitch of the stator core 4 (the same as the teeth pitch) is set to τs, and the difference between the outer diameter at the center of the permanent magnet 6 and the inner diameter of the stator core 4 is set to Lg as the airgap length. The flanged U-shaped magnet presser 10 is disposed between adjacent permanent magnets 6.

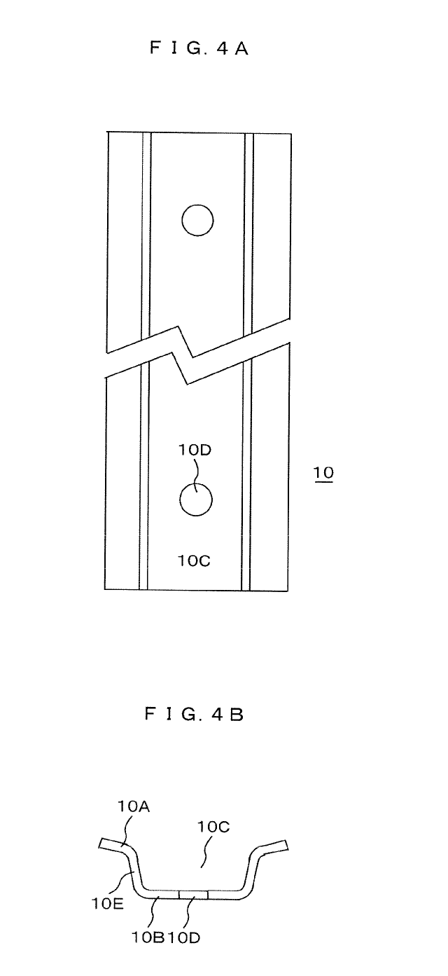

FIGS. 4A to 4D represent the outline of the magnet presser according to the embodiment. The magnet presser 10 of the embodiment has a flanged U-like shape, which is made of the non-magnetic conductive metallic material.

FIG. 4A is a plan view, and FIG. 4B is a sectional view of the magnet presser 10 according to the embodiment. Referring to FIGS. 4A and 43, the magnet presser 10 includes a flange 10A, a screw hole 10D, a plate 10B for connecting the flanges 10A for pressing the different permanent magnets 6, and a center recess portion 10C formed in the center of the magnet presser. The inner peripheral side of the flange 10A is formed to have substantially the same shape as the outer periphery of the permanent magnet. This makes it possible to rigidly hold the permanent magnet 6 from the outer periphery with the flange 10A of the magnet presser.

The magnet presser 10 may be produced by subjecting an aluminum flat plate, for example, the plate A5052 to the press forming. The aluminum flat plate A5052 has following advantages. That is, among the aluminum materials, it contains impurities, and exhibits relatively higher electric resistance (4.9 μΩcm) so as to lessen the eddy current generated in the magnet presser 10. Additionally, it can be purchased at a lower cost, and further exhibits relatively higher mechanical strength. In this case, the thickness of the magnet presser is kept constant over the entire region in the peripheral direction as shown in the drawing.

If the magnet presser 10 is produced through pressing, the respective parts between the flange 10A and the slope 10E, and between the plate 10B and the slope 10E of the magnet presser are formed to have rounded shapes as shown in the drawing.

The aforementioned structure provides the advantage which allows reduction in the eddy current loss as described later by the center recess portion 10C formed in the magnet presser 10. The generally employed structure does not have the center recess portion, which is filled with the non-magnetic metallic material as disclosed in Japanese Unexamined Patent Application Publication No. 2013-62897.

FIGS. 4C and 4D show the structure of the magnet presser 10 of another type according to the embodiment. FIG. 4C is a plan view, and FIG. 4D is a sectional view of the magnet presser 10. Likewise the magnet presser 10 shown in FIGS. 4A and 4B, it has a flanged U-like shape, and is produced through the drawing process as the manufacturing method.

The aluminum material, especially the soft one numbered with A6063 may be easily subjected to the drawing process. However, it exhibits the specific resistance of 3.19 μΩcm, which is lower than that of the aluminum A5052. Therefore, the eddy current loss becomes larger compared with the case where the aluminum fiat plate A5052 is used for forming the same shape. As the material itself is so soft that the resultant mechanical strength is weak. Meanwhile, the thickness tha of the flange 10A may be made different from each thickness of the plate 10B and the slope 10E of the magnet presser as shown in the drawing, providing the large freedom degree of shaping and reducing the manufacturing mold size. For example, it is possible to produce the magnet presser 10 with high mechanical strength and small eddy current loss by reducing the thickness tha of the flange 10A at the outer peripheral side where large eddy current is generated, and increasing the thickness thb of the plate 10B of the magnet presser at the inner diameter side with small eddy current generation.

A cut portion 10A1 is formed at the leading end of the flange 10A as shown in the drawing so as to reduce the eddy current loss without deteriorating the mechanical strength.

In the case where the stainless steel is used as the material for forming the magnet presser 10, machining is necessary as it is difficult to realize the shape as shown in FIGS. 4A and 4B through the drawing process, resulting in disadvantage of cost increase. On the contrary, there may be an advantage of reducing conductivity (71 μΩcm in the case of SUS 303), which allows reduction in the eddy current loss owing to the slot ripple.

The aforementioned structure ensures that the permanent magnet 6 is fixed with the flange 10A of the flanged U-like magnet presser from the outer periphery so as to directly suppress the centrifugal force applied to the permanent magnet 6 in the rotation.

The plate 10B disposed between the adjacent permanent magnets and the slope 10E of the flanged U-shaped magnet presser 10 serve to position the permanent magnet 6 in the circumferential direction, and the torque generated by the current flowing to the permanent magnet and the stator winding 5 serves to suppress the circumferential force applied to the permanent magnet.

Furthermore, a gap 12 is formed at the inner peripheral side of the magnet presser 10, and the magnet presser 10 is fixed to an outer circumferential cylinder portion 7A of the rotor core with the fixing member 11. In other words, the permanent magnet is fixed to the rotor core from the outer periphery with the fixing member and the like without bringing the magnet presser on the inner circumferential surface of the rotor into contact with the rotor core. This makes it possible to apply the force capable of directly withstanding against the centrifugal force to the permanent magnet 6 from the magnet presser 10, thus ensuring rigid magnet holding. The number of the fixing members 11 in the circumferential direction may be increased in accordance with the number of rotations, the maximum torque and the like.

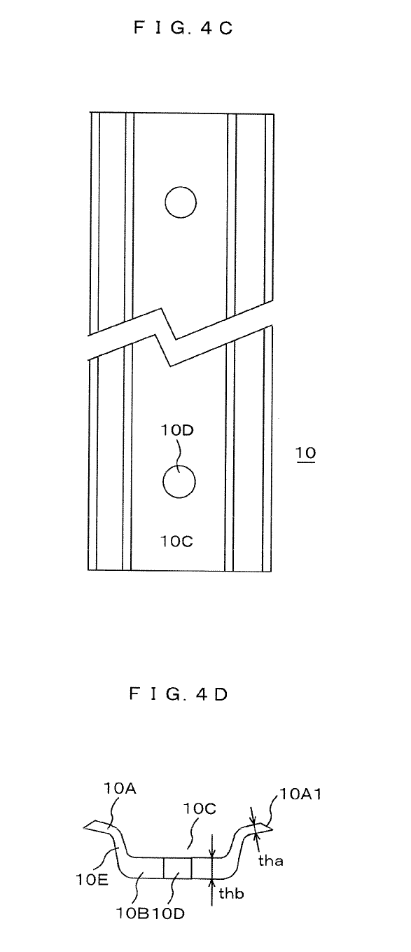

FIGS. 5A and 5B are explanatory views representing the principle concerning generation of the eddy current in the magnet presser. The eddy current generated in the magnet presser includes the eddy current loss (non-load state) generated when the current is not applied to the stator winding 5, and the eddy current (load state) generated when the current is applied to the stator winding.

In the non-load state, the magnetic flux flowing through the permanent magnet is partially applied to the stator core teeth part from the permanent magnet 6 via the magnet presser 10 and the airgap between the stator and the rotor as a broken line φm of FIG. 3 shows. In this case, focusing the point in the magnetic circuit of the magnet presser, two cases may occur, that is, the case that the magnetic flux flows to the stator teeth 4B from the permanent magnet 6 via the magnet presser 10 and the airgap to increase the magnetic flux density, and the case that the magnetic flux flows to the stator slit 4D and the stator teeth 4B from the permanent magnet 6 via the magnet presser 10 and the airgap in the rotation to lower the magnetic flux density. This is caused by the high magnetic resistance of the stator slit 4D. If the magnetic flux density at the single point of the magnet presser 10 fluctuates and the magnetic presser 10 is conductive, the eddy current flows around the conductive magnet presser 10, thus generating the eddy current loss. This is the principle concerning generation of the eddy current in the non-load state.

The principle concerning generation of the eddy current in the state where the current is applied to the stator winding is described below. FIG. 5A represents the principle concerning generation of the eddy current in the magnet presser upon application of the current to the stator winding. In this case, it is assumed that the eddy current is generated between N and S poles of the permanent magnets 6 in the circumferential direction corresponding to the single cycle at the electric angle of the permanent magnet dynamoelectric machine as shown in FIGS. 1 and 3. Upon application of sinusoidal currents with phases each at different electric angle by 120° to the 3-phase stator winding, the 2-pole and 9-slot structure converts the magnetomotive force generated by the stator winding 5 into the waveform with 9 stepped portions at the single cycle. The magnetic flux corresponding to the fundamental wave of the magnetomotive force of the stator winding moves without fluctuation along with the rotor movement. As it corresponds to the direct current on the magnet presser, no eddy current is generated (more accurately, the eddy current is generated under the influence of the stator slit as described above). Meanwhile, the stepped high harmonic of magnetomotive force corresponding to 9 times as high as the fundamental frequency changes in accordance with rotation of the rotor. This may fluctuate density of the magnetic flux of the magnet presser, thus generating the eddy current.

FIG. 5B represents calculation results of the magnetic flux density fluctuation on the outer peripheral surface of the magnet presser, and the eddy current density generated as a result of the fluctuation. As the drawing shows, in the case of the dynamoelectric machine with 2-pole and 9-slot structure of the embodiment, pulsation of the magnetic flux density maximizes the component of the frequency 9 times the power source as the base. The magnetic flux density of the magnet presser is obtained by superimposing the direct current component on the magnetic flux density as shown in the drawing.

The magnetic flux density pulsation and the eddy current density of the magnet presser in the load state are generated as the component corresponding to 9 times the frequency along with the rotor rotation. The same phenomenon may be observed in the non-load state as described above.

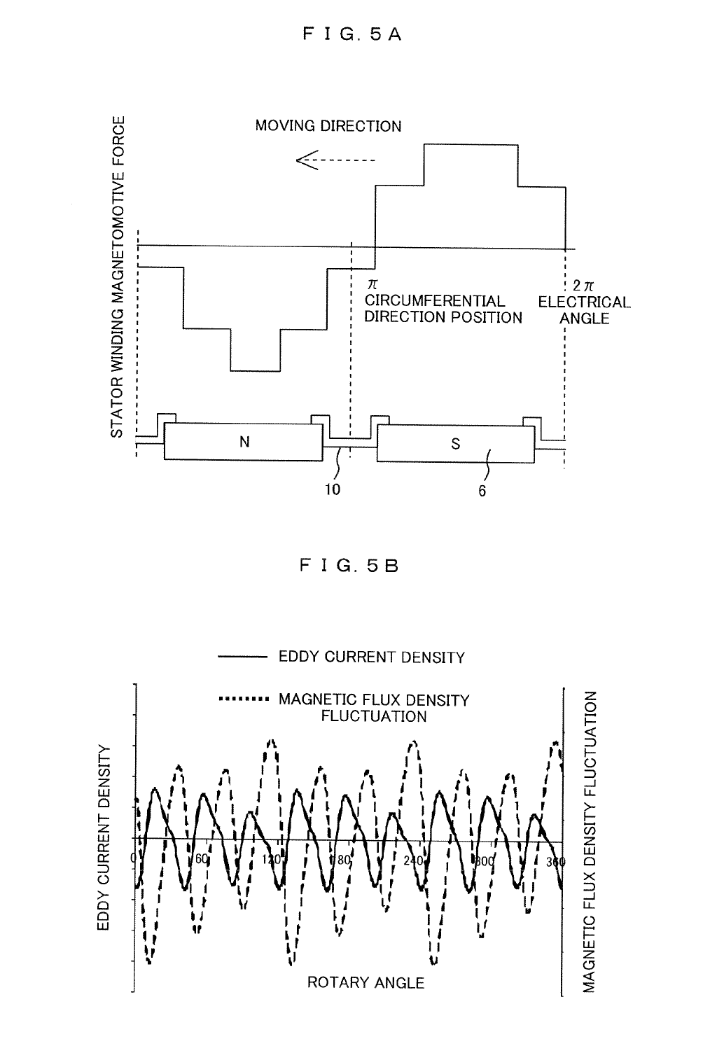

FIG. 6 graphically represents analytical results with respect to the magnetic flux density fluctuation and the eddy current loss which are generated in the magnet presser at its outermost peripheral position. Referring to FIG. 6, the x-axis represents the distance Lw between the outermost periphery of the magnet presser and the inner radius of the stator, which is expressed as the ratio to the airgap length Lg corresponding to the distance from the inner radius Rsi of the stator to the outer diameter of the permanent magnet center. Accordingly, the outer circumferential surface of the rotor (that is, the outer diameter position of the permanent magnet center) may be defined as the position apart from the inner radius of the stator by 1 unit (1.0 on x-axis). The y-axis represents the value of the magnetic flux density fluctuation in reference to the value of the inner radius Rsi of the stator in the state where the current is applied to the stator winding. The analysis is conducted in accordance with the magnetic analytical program. Also, the analysis is conducted with respect to the configuration of the magnet presser with no center recess portion 10C. FIG. 6 represents the eddy current loss and the magnetic flux density fluctuation which occur in the magnet presser 10 made of the aluminum material as the non-magnetic metal, having the center recess portion 10C filled with the same material. Actually, it is impossible to obtain those values of the magnet presser 10 at the Rsi position. Therefore, they are obtained by extrapolation of values at the side close to the inner periphery.

The aforementioned calculation results show that the magnetic flux density fluctuation and the eddy current loss are maximized when the outermost peripheral position of the magnet presser is located at the inner circumferential position of the stator (inner radial position of the stator). As the position moves toward the inner circumference, those values decrease. In other words, the magnetic flux density fluctuation and the eddy current loss become larger at the part near the inner circumference of the stator core.

In this embodiment, the magnet presser is formed into the flanged U-like shape having the center recess portion 100 in the outermost periphery. This makes it possible to have the gap in the part near the inner circumference of the stator core where the magnetic flux density fluctuation and the eddy current loss become large so as to lessen the number of areas where the eddy current is generated, and the eddy current loss. The calculation results show that the flanged U-shaped magnet presser with the center recess portion 10C according to the embodiment ensures to reduce the eddy current loss generated in the magnet presser 10 to 1/20 compared with the magnet presser with filled center recess portion 100. The mechanical strength that is significantly dominated by the thickness of the flange 10A is not influenced by the center recess portion 10C.

The calculation results further show that the structure having the outermost periphery of the flanged U-shaped magnet presser separated from the inner circumference of the stator toward the inner radial side by the length twice or more than the airgap length Lg allows marked reduction in the eddy current loss. Referring to FIG. 6, the structure having the outermost periphery of the flanged U-shaped magnet presser separated from the inner circumference of the stator by twice the airgap length Lg toward the inner circumferential side makes it possible to suppress the magnetic flux density fluctuation of the magnet presser to 0.5 or less with respect to the inner circumferential position of the stator at the point 2.0 on the x-axis. Furthermore, the eddy current loss may be reduced to approximately 0.25 or smaller, ensuring to realize sufficiently practical region.

The slot ripple frequency 9 times the power source frequency spatially corresponds to the single slot, which is expressed by the distance of the slot pitch τs shown in FIG. 3. The single cycle of the magnetic flux distribution of higher harmonic wave corresponding to the slot ripple frequency is equivalent to τs. Attenuation is conducted to zero at the distance τs/4 corresponding to ¼ of the distance. In the trial calculation with respect to the permanent magnet dynamoelectric machine, is is equivalent to 19 times the airgap. in view of the above description, converting the outermost peripheral position of the magnet presser into the slot pitch τs, sufficient attenuation of the magnetic flux density fluctuation is obtained at the position half the one as described above, that is, τs/Lg/8 (=19 Lg/Lg/8=2.375), thus ensuring to lessen the eddy current loss. The result in FIG. 6 shows that the aforementioned structure ensures the sufficiently practicable region by setting the magnetic flux density fluctuation to 0.4 or smaller at the inner circumferential position of the stator and the eddy current loss to 0.2 or smaller corresponding to the position of 2.375 on the x-axis.

Firstly, the permanent magnet dynamoelectric machine according to the embodiment is configured to have the non-magnetic conductive permanent magnet presser as a flanged U-shaped metal, having a gap between the inner periphery of the magnet presser and the outer circumference of the rotor core, and fixing the permanent magnet to the rotor core from the outer circumference via the flange of the magnet presser using the fixing member. This ensures to realize the structure for positioning the permanent magnet and rigidly fixing the centrifugal force applied to the permanent magnet.

Secondly, the structure is designed to have the thickness of the permanent magnet gradually reduced in the circumferential direction so as to gradually increase the circumferential airgap length. The position of the magnet presser may be located closer to the inner circumferential side, and the pulsation torque may be reduced.

Thirdly, the magnet presser is formed to have the flanged U-like shape. This makes it possible to remove the outer peripheral center part of the magnet presser as the part where the generated eddy current is maximized while retaining the mechanical strength of the magnet holder, and to minimize the eddy current loss generated in the magnet presser.

As described above, according to the embodiment, a permanent magnet dynamoelectric machine is composed of a stator formed by winding a stator winding around a laminated stator core, and a permanent magnet rotor on an inner circumference of the stator, which includes a shaft, a rotor core, permanent magnets, each of which is made of a segment-shaped rare earth magnet, and disposed to have adjacent polarities alternately changed on an outer circumference of the rotor core, and a magnet presser which determines a circumferential position of the permanent magnet and presses a part of an outer periphery of the permanent magnet. The magnet presser is made of a conductive metal, and formed to have a flanged U-like shape. The magnet presser is fixed to the rotor core with a fixing member so as to fix the part of the outer periphery of the permanent magnet in a radial direction with a flange of the magnet presser.

The permanent magnet has the outer peripheral radius equal to or smaller than ½ of the inner radius of the stator.

The magnet presser is configured to be fixed to the rotor core via a gap with the fixing member.

The outermost periphery of the magnet presser is separated from the inner diameter of the stator core by the distance equal to twice the airgap length Lg or more toward the inner circumferential side.

The outermost periphery of the magnet presser is separated from the inner diameter of the stator core by the distance equal to ⅛ times the ratio τs/Lg between the slot pitch and the airgap length or more toward the inner circumferential side.

The magnet presser is configured such that the thickness of the flange for pressing the permanent magnet in the radial direction is the same as the thickness of the plate for connecting the flanges that press the permanent magnets with different polarities.

The magnet presser is configured such that the thickness of the flange for pressing the permanent magnet in the radial direction is different from the thickness of the plate for connecting the flanges that press the permanent magnets with different polarities.

The magnet presser is manufactured through the drawing process.

As described above, it is possible to provide the permanent magnet dynamoelectric machine of surface magnet type with large-torque, high-speed and large-capacity, and low torque ripple.

### Second Embodiment

This embodiment describes the flanged U-shaped magnet presser formed by using two different materials.

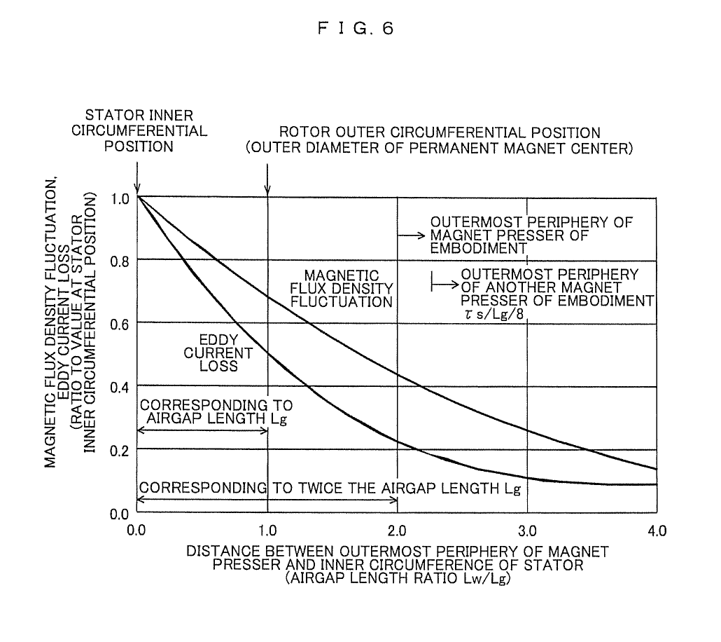

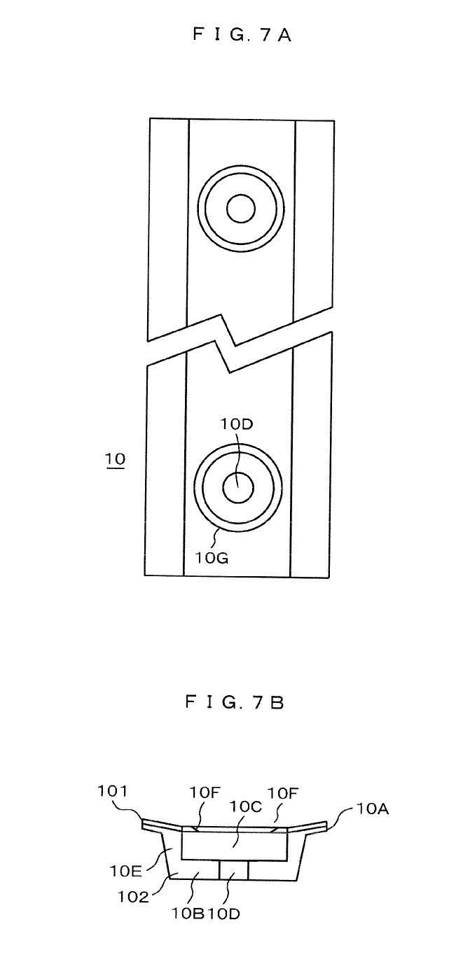

FIGS. 7A and 7B show the outline of the magnet presser. FIG. 7A is a plan view, and FIG. 7B is a sectional view of the magnet presser 10 according to this embodiment. Referring to FIGS. 7A and 7B, the magnet presser 10 includes a first component 101 positioned at the outer circumferential side of the rotor and a second component 102 positioned at the inner circumferential side of the rotor. The second component 102 of the magnet presser includes a flange 10A as the outer peripheral part, a plate 10B, a center recess portion 10C, and a screw hole 10D of the magnet presser.

For example, the thin stainless plate is used for producing the first component 101 of the magnet presser to form the structure having a center recess portion 10F as the space above the first component 101. This ensures the mechanical strength and suppresses the eddy current generated by the magnetic flux density fluctuation (owing to large intrinsic resistance). Furthermore, the structure may be easily manufactured only by cutting and drilling the thin plate. The use of the aluminum material for producing the second component 102 of the magnet presser at the position separated from the inner circumferential surface of the stator allows easy manufacturing through the drawing process while minimizing the eddy current loss. It is possible to fix the first component 101 and the second component 102 of the magnet presser through adhesion or screwing.

A radially inclined hole 10G for the flat screw may be formed in the first component 101 so as to integrally fix the first component 101 and the second component 102 with the flat screw. The non-conductive and non-metallic material may be used for producing the second component 102 of the magnet presser. This may eliminate the eddy current loss generated in the second component 102.

As described above, the magnet presser according to the embodiment is configured to include the first component for externally pressing the permanent magnet, and the second component disposed between the permanent magnets to fix positions thereof. Both the components are made of different materials.

The present invention is not limited to the aforementioned embodiments, but may include various modifications. For example, the embodiment takes the magnet presser integrally formed in the axial direction as an example. However, the axially separated structure is capable of lessening the eddy current loss while retaining the mechanical strength. The structure having the magnet presser formed intermittently in the axial direction may further lessen the eddy current loss by sacrificing the mechanical strength to a certain degree. A plurality of slits or spaces are circumferentially formed in the points of the flange in the axial direction of the magnet presser allow lessening of the eddy current loss although the mechanical strength is deteriorated. The embodiments have been described in detail for better understanding of the invention, and are not necessarily restricted to the one provided with all the structures of the description. The structure of any one of the examples may be partially replaced with that of another example. Alternatively, it is possible to add the structure of any one of the examples to that of another example. It is also possible to have the part of the structure of the respective examples added to, removed from and replaced with another structure.

What is claimed is:

1. A permanent magnet dynamoelectric machine comprising:
a stator formed by winding a stator winding around a laminated stator core; and
a permanent magnet rotor on an inner circumference of the stator, which includes a shaft, a rotor core, permanent magnets, each of which is made of a segment-shaped rare earth magnet, and disposed to have adjacent polarities alternately changed on an outer circumference of the rotor core, and a magnet presser which determines a circumferential position of the permanent magnet and presses a part of an outer periphery of the permanent magnet,
wherein the magnet presser is made of a conductive metal, and formed to have a flanged U-like shape, and
the magnet presser is fixed to the rotor core with a fixing member so as to fix the part of the outer periphery of the permanent magnet in a radial direction with a flange of the magnet presser.

2. The permanent magnet dynamoelectric machine according to claim 1, wherein the permanent magnet has an outer peripheral radius equal to or smaller than ½ of an inner radius of the stator.

3. The permanent magnet dynamoelectric machine according to claim 1, wherein the magnet presser is fixed to the rotor core via a gap with the fixing member.

4. The permanent magnet dynamoelectric machine according to claim 1, wherein when an airgap length from an inner diameter of the stator core to an outer diameter of a center of the permanent magnet is set to Lg, an outermost periphery of the magnet presser is separated from the inner diameter of the stator core by a distance equal to twice the airgap length Lg or more toward the inner circumferential side.

5. The permanent magnet dynamoelectric machine according to claim 1, wherein when a slot pitch of the stator core is set to τs, and the airgap length from the inner diameter of the stator core to the outer diameter of the permanent magnet center is set to Lg, the outermost periphery of the magnet presser is separated from the inner diameter of the stator core by a distance equal to ⅛ times the τs/Lg or more toward the inner circumferential side.

6. The permanent magnet dynamoelectric machine according to claim 1, wherein the magnet presser is configured such that a thickness of the flange for pressing the permanent magnet in the radial direction is the same as a thickness of a plate for connecting the flanges that press the permanent magnets with different polarities.

7. The permanent magnet dynamoelectric machine according to claim 1, wherein the magnet presser is configured such that a thickness of the flange for pressing the permanent magnet in the radial direction is different from a thickness of a plate for connecting the flanges that press the permanent magnets with different polarities.

8. The permanent magnet dynamoelectric machine according to claim 1, wherein the magnet presser is manufactured through a drawing process.

9. The permanent magnet dynamoelectric machine according to claim 1, wherein the magnet presser includes a first component for externally pressing the permanent magnet and a second component disposed between the permanent magnets for fixing positions thereof, both of which are made of different materials.
